(19) United States
(12) Patent Application Publication
(10) Pub. No.: US 2012/0146981 A1
(43) Pub. Date: Jun. 14, 2012

(54) DRIVING METHOD OF DISPLAY APPARATUS AND DISPLAY APPARATUS FOR DISPLAYING FRAME

(76) Inventors: Chee-Wai Lau, Hsin-Chu (TW); Cheng-Nan Yeh, Hsin-Chu (TW); Tsang-Hong Wang, Hsin-Chu (TW)

(21) Appl. No.: 13/303,157

(22) Filed: Nov. 23, 2011

(30) Foreign Application Priority Data
Dec. 14, 2010 (TW) 099143673

(51) Int. Cl. G09G 3/32; G06F 3/038

(52) U.S. Cl. 345/211; 345/82

(57) ABSTRACT

A driving method for a display apparatus. The display apparatus includes a plurality of first pixel units, a plurality of second pixel units, a first group of transmission lines and a second group of transmission lines. The first group of transmission lines and the second group of transmission lines are electronically connected to the plurality of first pixel units and the plurality of second pixel units, respectively. The driving method includes: generating a first and a second input signals including a plurality of input signals each having an identical waveform; and transmitting the first and the second input signals into the first group and second group of transmission lines such that the first and second input signals are transmitted to the plurality of first pixel units and the plurality of second pixel units in a plurality of different transmission directions, respectively.

### BACKGROUND OF THE INVENTION

1. Field of the Invention

The present invention relates to a driving method for a display apparatus and related display apparatus, and more particularly, to a driving method that is based on symmetrical signal transmission and utilized in a display apparatus and related display apparatus.

2. Description of the Prior Art

With the development of computer display screens, mobile phones, personal digital assistants (PDAs), flat panel televisions and other communication/entertainment technologies, the market demand for light emitting panels is increasing. However, as to a large-sized panel, each pixel unit within the panel requires to receive operational signals (e.g., a reference voltage signal, a gate signal, a data signal, etc.) via transmission lines. Therefore, two pixel units that are located at two sides of the same panel may receive operation signals that have an identical waveform but different intensity due to parasitic impendence of a long transmission line, leading to poor performance of the panel. For example, please refer to FIG. 1, which is a diagram illustrating an operation of a conventional panel 100. The conventional panel 100 includes a plurality of pixel structures P arranged in a matrix. If the pixel structures P that are disposed in the same row receive an operational signal S via a transmission line L and the operational signal S is generated at the left side of the conventional panel 100, and propagates from left to right via the transmission line L, the leftmost pixel structure P and the rightmost pixel structure P which are disposed in the same row receive the operational signal S of different intensity due to the parasitic impendence of the transmission line L. As shown in FIG. 1, the intensity of operational signals S received by the pixel structures P which are disposed in the same row is gradually decreasing from left to right. Therefore, the conventional panel 100 generally has the problem of un-uniform brightness, resulting in a degraded visual effect.

### SUMMARY OF THE INVENTION

In order to solve the aforementioned problem, the present invention provides a driving method that is based on symmetric signal transmission and utilized in a display apparatus and related display apparatus. By performing symmetric compensation upon one or more signals and transmitting signals that have the same type to each pixel structure from different symmetric directions, the problem of un-uniform brightness of the whole panel can be mitigated greatly, thereby offering a favorable visual effect.

According to one aspect of the present invention, an exemplary driving method for a display apparatus is provided. The display apparatus includes a plurality of first groups of pixel units, a plurality of second groups of pixel units, a first group of transmission lines and a second group of transmission lines. The first group of transmission lines and the second group of transmission lines are electrically connected to the first groups of pixel units and the second groups of pixel units, respectively. The exemplary driving method includes: generating a first input signal and a second input signal, the first input signal and the second input signal including a plurality of input signals each having an identical waveform; and transmitting the first input signal and the second input signal to the first group of transmission lines and the second group of transmission lines, respectively, such that the first input signal and the second input signal being transmitted to the first groups of pixel units and the second groups of pixel units according to a plurality of different signal transmission directions, respectively.

According to another aspect of the present invention, an exemplary display apparatus is provided. The exemplary display apparatus includes a first pixel unit, a second pixel unit, a first transmission line, a second transmission line, a first input signal generating circuit and a second input signal generating circuit. The first pixel unit and the second pixel unit are utilized for displaying a frame. The first transmission line and the second transmission line are coupled to the first pixel unit and the second pixel unit, respectively. The first input signal generating circuit and the second input signal generating circuit are coupled to the first transmission line and the second transmission line, respectively. The first input signal generating circuit and the second input signal generating circuit generate a first input signal and a second input signal each having an identical waveform, respectively, and transmit the first input signal and the second input signal via the first transmission line and the second transmission line according to a plurality of different signal transmission directions, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an operation of a conventional panel.

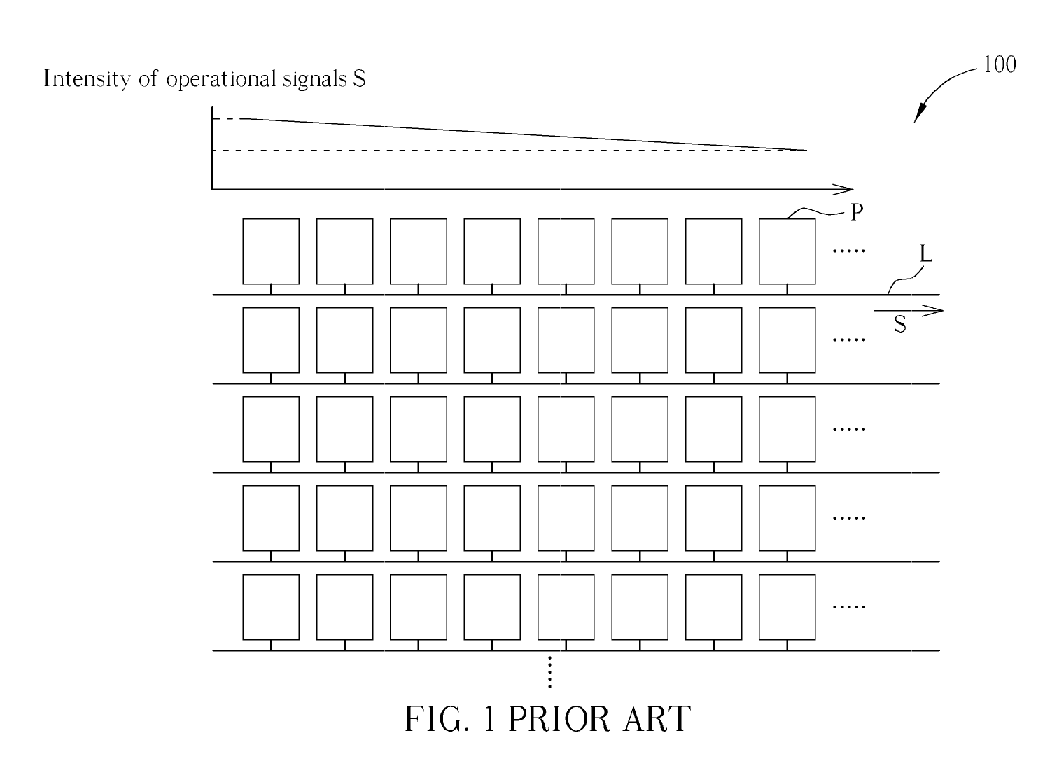

FIG. 2A is a diagram illustrating part of a display apparatus realized by an exemplary embodiment of the present invention.

FIG. 2B is a diagram illustrating part of a sectional structure of a pixel structure within the display apparatus shown in FIG. 2A.

FIG. 3 is a diagram illustrating part of a display apparatus realized by another exemplary embodiment of the present invention.

FIG. 4 is a diagram illustrating a structure of a first pixel unit realized by an exemplary embodiment of the present invention.

FIG. 5A is a diagram illustrating part of a display apparatus realized by another exemplary embodiment of the present invention.

FIG. 5B is a diagram illustrating a signal transmission structure of the display apparatus shown in FIG. 5A.

FIG. 5C is a timing diagram illustrating some of the signals shown in FIG. 5B.

FIG. 6 is a diagram illustrating part of a display apparatus realized by another exemplary embodiment of the present invention.

FIG. 7 is a diagram illustrating part of a display apparatus realized by another exemplary embodiment of the present invention.

FIG. 8 is a diagram illustrating part of a field emission display realized by an exemplary embodiment of the present invention.

### DETAILED DESCRIPTION

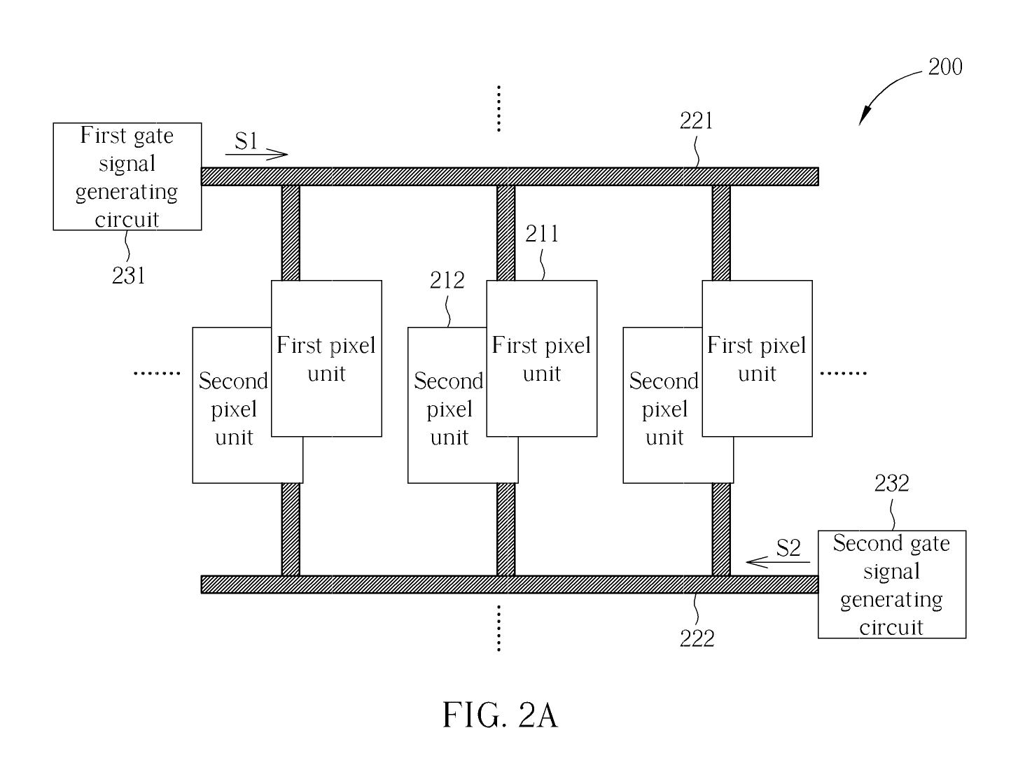

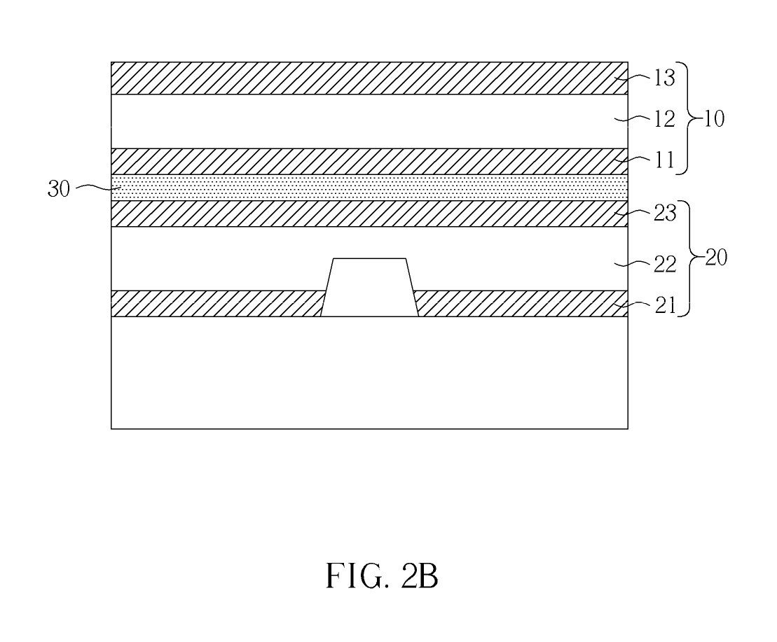

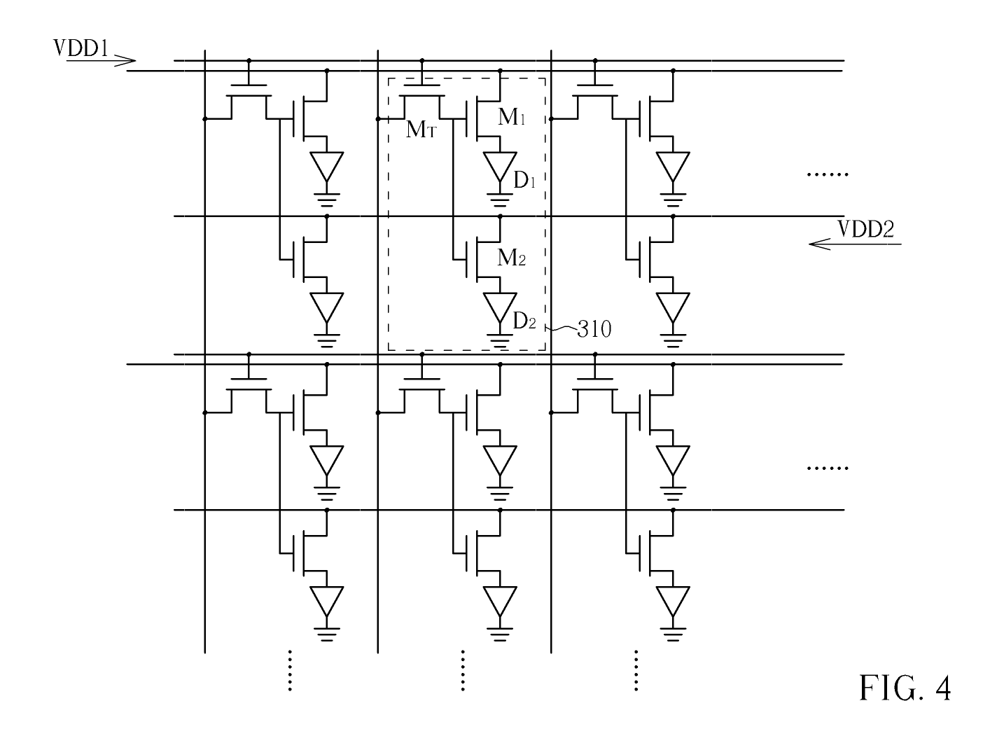

Please refer to FIG. 2A, which is a diagram illustrating part of a display apparatus 200 realized by an exemplary embodiment of the present invention. The display apparatus 200 includes a plurality of pixel structures, a plurality of transmission lines and a plurality of signal generating circuits. For brevity, FIG. 2A only shows some components of the display apparatus 200, which include a first pixel unit 211, a second pixel unit 212, a first transmission line 221, a second transmission line 222, a first gate signal generating circuit 231 and a second gate signal generating circuit 232. The pixel units, including the first pixel unit 211 and the second pixel unit 212, are utilized for displaying a video frame on the display apparatus 200. The first transmission line 221 is parallel with and adjacent to the second transmission line 222; besides, the first transmission line 221 and the second transmission line 222 are coupled to the first pixel unit 221 and the second pixel unit 212, respectively. The first gate signal generating circuit 231 and the second gate signal generating circuit 232 are coupled to the first transmission line 221 and the second transmission line 222, respectively. The first gate signal generating circuit 231 and the second gate signal generating circuit 232 respectively generate a first gate signal S1 and a second gate signal S2 each having an identical waveform, and then transmit the first gate signal S1 and the second gate signal S2 via the first transmission line 221 and the second transmission line 222 according to a plurality of different signal transmission directions (e.g., one direction from left to right and another direction from right to left), respectively. In this exemplary embodiment, the first gate signal S1 and the second gate signal S2 are utilized for illustrating the technical features of the present invention. However, it is not meant to be a limitation of the present invention. The present invention may also utilize data signals or reference voltages to realize the technical features. For example, please refer to FIG. 4, which is a diagram illustrating part of a display apparatus 300 realized by another exemplary embodiment of the present invention. The display apparatus 300 includes a plurality of pixel structures arranged in a matrix. Taking a pixel structure 310 for example, the pixel structure 310 includes a switch transistor M_{T}, transistors M₁ and M₂ and organic light emitting diodes (OLEDs) D₁ and D₂. As those skilled in the art should readily understand the operation of the pixel structure 310, further description is therefore omitted here for brevity. As to the pixel structure 310, the transistors M₁ and M₂ receive a reference voltage signal VDD1 that is transmitted rightwards and a reference voltage signal VDD2 that is transmitted leftwards, respectively. So, even though the reference voltage signal VDD1/VDD2 is attenuated after transmitted for a long distance and inevitably affects the operation of the OLED D₁/D₂, after compensated by the OLED D₂/D₁ which receives the reference voltage signal VDD2/VDD1, an overall effect of the OLEDs D₁ and D₂ is maintained at a level identical to that of each pixel structure disposed in the same row, such that may present a favorable visual effect.

Please refer to FIG. 2B together with FIG. 2A to further understand a stacked structure shown in FIG. 2A. FIG. 2B is a diagram illustrating a partial sectional structure of a pixel structure within the display apparatus 200 realized by an exemplary embodiment of the present invention. The pixel structure includes a dielectric layer 30, a first OLED 10 and a second OLED 20, wherein the dielectric layer 30 is disposed between the first OLED 10 and the second OLED 20. That is, a stacked structure is formed by the first OLED 10, the dielectric layer 30 and the second OLED 20. Thus, the first OLED 10 has no direct contact with the second OLED 20. The first OLED 10 sequentially includes a top electrode 11, an organic material layer 12, and a bottom electrode 13 in a direction from top to bottom. The second OLED 20 sequentially includes a top electrode 21, an organic material layer 22, and a bottom electrode 23 in a direction from top to bottom. The first OLED 10 and the second OLED 20 are connected to corresponding circuit components, respectively. When the first OLED 10 and the second OLED 20 respectively receive driving signals to thereby emit light, the pixel structure generates a sum of light signals emitted by the first OLED 10 and the second OLED 20.

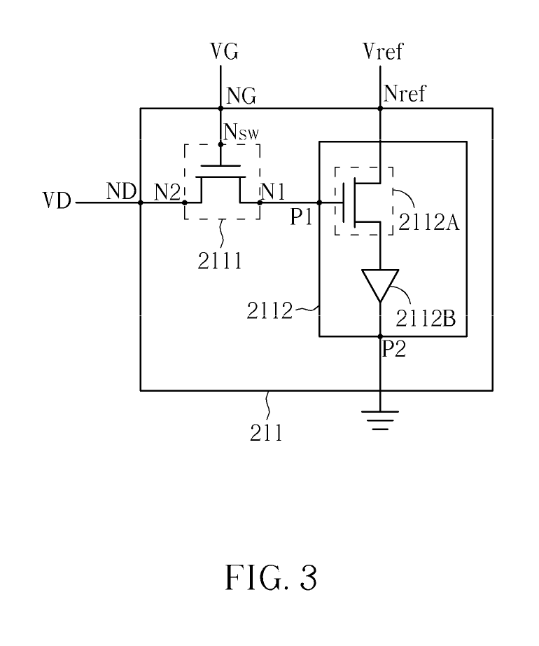

Please refer to FIG. 3 to further understand the first pixel unit 211. FIG. 3 is a diagram illustrating the first pixel unit 211 realized by an exemplary embodiment of the present invention. The first pixel unit 211 has a gate terminal NG for receiving a gate signal VG, a data terminal ND for receiving a data signal VD and a reference voltage terminal Nref for receiving a reference voltage signal Vref. The first pixel unit 211 includes a switch component 2111 and a light emitting component 2112, wherein the switch component 2111 includes a switch terminal N_{SW}, a first terminal N1 coupled to the reference voltage terminal Nref where the first terminal N1 is coupled to the reference voltage terminal Nref via an internal component of the light emitting component 2112, and a second terminal N2, is used for selectively conducting a data signal VD from the data terminal ND to the first terminal N1 according to the gate signal VG. Please note that, in this exemplary embodiment, the switch component 2111 is realized by a thin film transistor (TFT). However, it is not meant to be a limitation of the present invention. The switch component 2111 may be realized by another circuit with switch functionality. The light emitting component 2112 includes a first terminal P1 which is coupled to the first terminal N1 of the switch component 2111, and a second terminal P2 which is coupled to a ground terminal, and is used for emitting light according to the data signal VD. In this exemplary embodiment, the light emitting component 2112 includes a TFT 2112A and an OLED 2112B. However, it is not meant to be a limitation to the range of the present invention. The light emitting component 2112 may be realized by another circuit having the function of emitting light according to a specific signal. Moreover, since the function and structure of the second pixel unit 212 are substantially identical to that of the first pixel unit 211, further description is therefore omitted here for brevity.

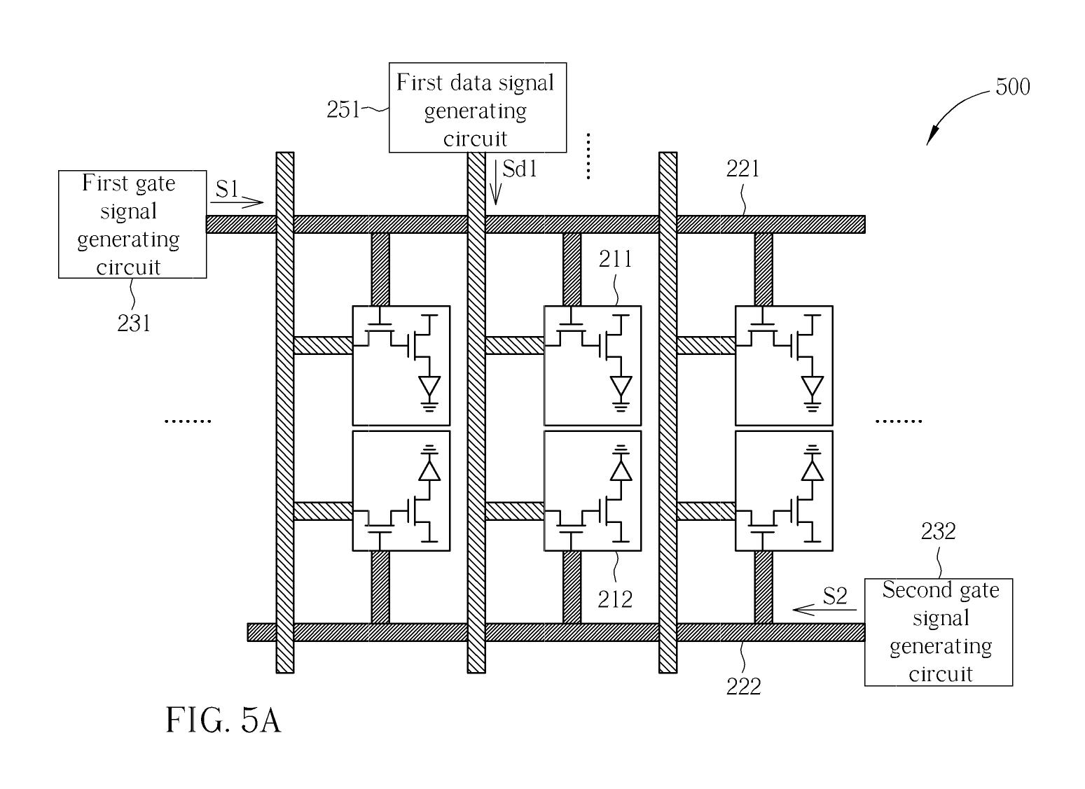

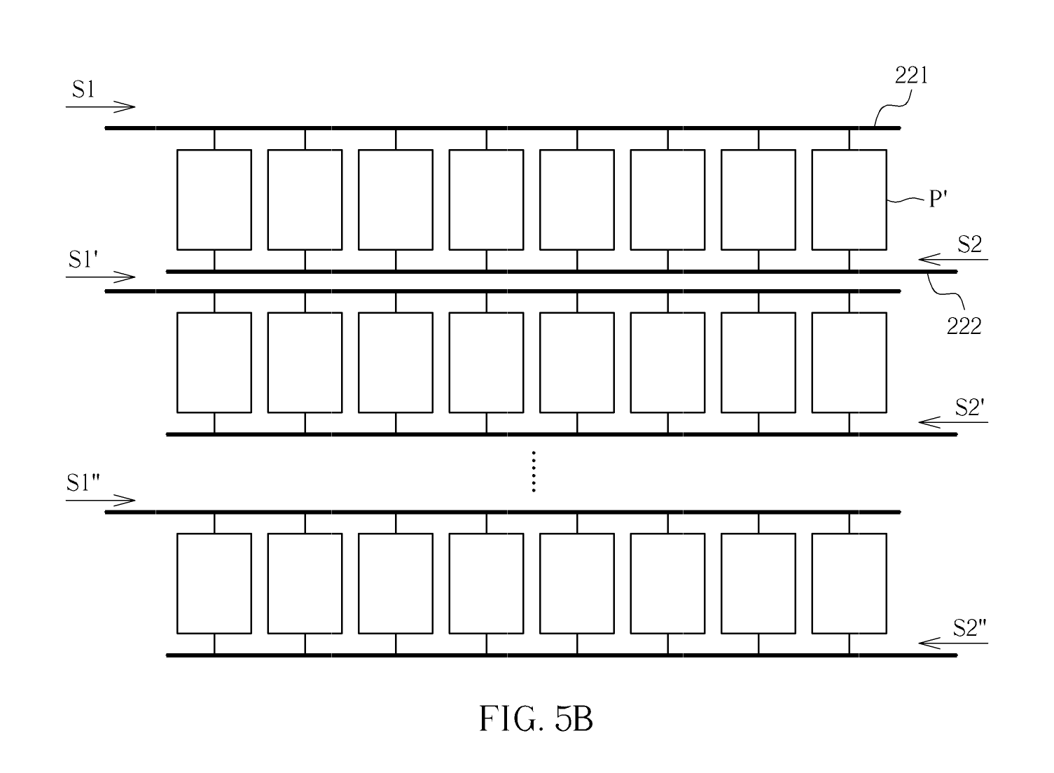

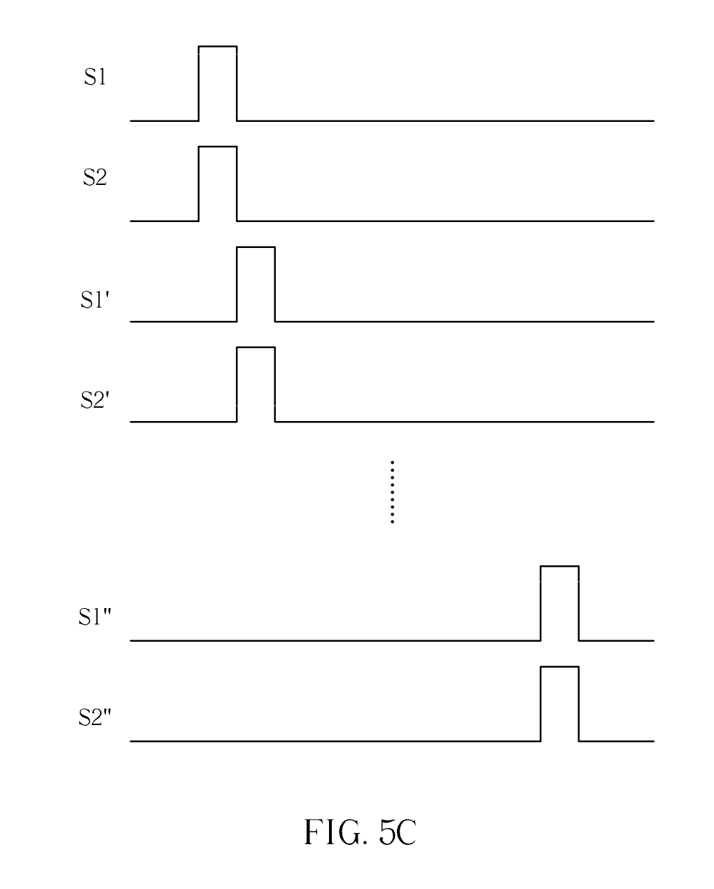

In this exemplary embodiment, the first gate signal S1 and the second gate signal S2 are pixel driving signals each having an identical waveform. The first transmission line 221 and the second transmission line 222 control the first pixel unit 211 and the second pixel unit 212 by transmitting gate signals each having an identical waveform (i.e., S1=S2), respectively, and selectively receive the same data signal during a same period according to the first gate signal S1 and the second gate signal S2. Please refer to FIG. 5A together with FIG. 4. FIG. 5A is a diagram illustrating part of a display apparatus 500 realized by an exemplary embodiment of the present invention. Compared with the display apparatus 200 shown in FIG. 2A, the display apparatus 500 includes a plurality of data lines, and one of the data lines 241 is simultaneously coupled to the first pixel unit 211 and the second pixel unit 212, and transmits a first data signal Sd1 generated by a data signal generating circuit 251 to the first pixel unit 211 and the second pixel unit 212. Besides, the gate terminals NG of the first pixel unit 211 and the second pixel unit 212 respectively receive the first gate signal S1 and the second gate signal S2 via the first transmission line 221 and the second transmission line 222, and the switch components within the first pixel unit 211 and the second pixel unit 212 are selectively switched on/off according to the first gate signal S1 and the second gate signal S2, respectively. Since the data terminals ND of the first pixel unit 211 and the second pixel unit 212 are both coupled to the same data line 241, the first pixel unit 211 and the second pixel unit 212 receive the same first data signal Sd1 during the same period.

Please further refer to FIG. 5B and FIG. 5C together with FIG. 5A. FIG. 5B is a diagram illustrating a signal transmission structure of the display apparatus 500 shown in FIG. 5A, wherein each pixel structure P′ includes two pixel units respectively identical to the first pixel unit 211 and the second pixel unit 212, for receiving a first gate signal and a second gate signal, respectively. FIG. 5C is a timing diagram illustrating part of the signals shown in FIG. 5B. As readily known from FIG. 5B, the pixel structures disposed in the same row receive signals with the same waveform and intensity. For example, the pixel structures disposed in the topmost row shown in FIG. 5B receive the first gate signal S1 and the second gate signal S2, while the pixel structures disposed in the second row adjacent to the topmost row receive the first gate signal S1′ and the second gate signal S2′, and pixel structures disposed in the bottommost row receive the first gate signal S1″ and the second gate signal S2″. As readily known from FIG. 5C, the first gate signal S1 and the second gate signal S2 have the same transmission timing. That is, the first gate signal S1 and the second gate signal S2 with the same waveform are simultaneously generated at opposite sides of the display apparatus 500, and then propagate rightwards and leftwards to the pixel structures disposed in the same topmost row, respectively. So, even if the first gate signal and the second gate signal respectively suffer from attenuation during the long-distance transmission, a sum of intensity of the first gate signal and the second gate signal received by each pixel structure in the same row during the same period would be the same.

Besides, the spirit of the present invention is to provide a plurality of input signals in a plurality of different symmetric directions (e.g., directions with rotational symmetry) to a pixel structure, such that a sum of intensity of the input signals received by each pixel structure is substantially the same. In the exemplary embodiment of FIG. 5A, the display apparatus 500 utilizes the gate signals as the input signals for implementing symmetric compensation. However, this structure is not meant to be a limitation of the range of the present invention. In other exemplary embodiments of the present invention, the display apparatus 500 may utilize other pixel driving signals, such as reference voltage signals or data signals, as the input signals for implementing symmetric compensation.

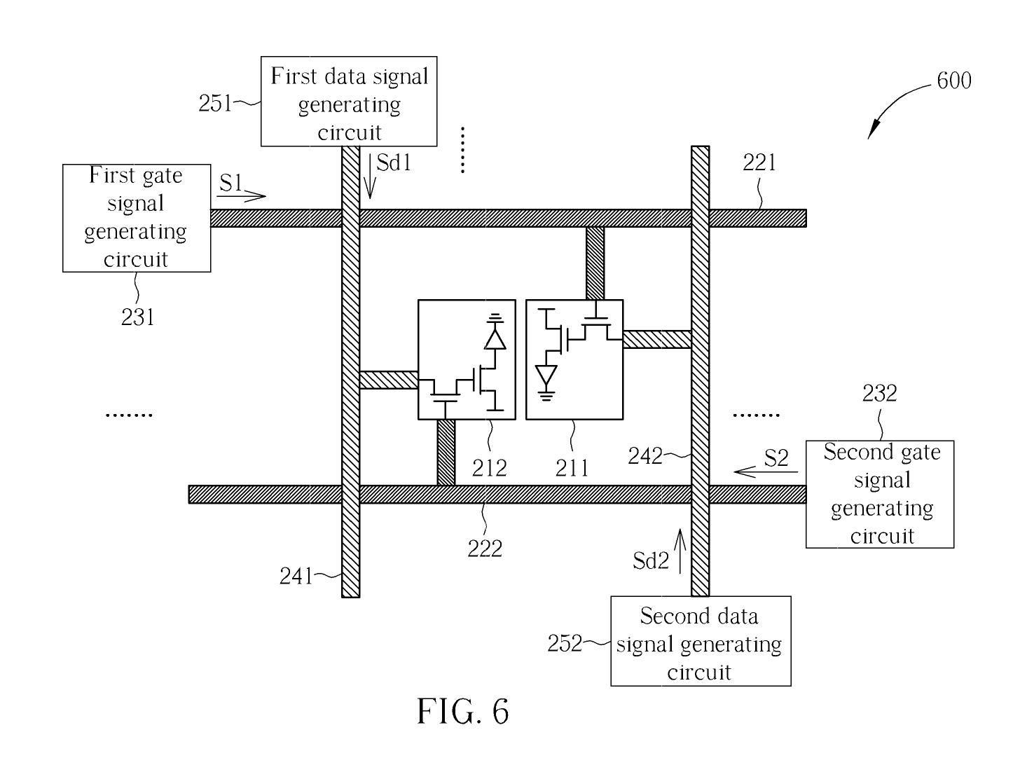

Moreover, the present invention is not limited to compensating for a single type of input signals, and may simultaneously utilize a plurality of types of input signals to achieve symmetric compensation. For example, please refer to FIG. 6, which is a diagram illustrating part of a display apparatus 600 realized by another exemplary embodiment of the present invention. Different from the display apparatus 500 shown in FIG. 5A, the display apparatus 600 simultaneously utilizes data signals and gate signals to implement symmetric compensation. The display apparatus 600 includes data lines 241, 242, a first data signal generating circuit 251, and a second data signal generating circuit 252. In the exemplary embodiment of FIG. 6, the first data signal generating circuit 251 and the second data signal generating circuit 252 are utilized for generating the first data signal Sd1 and the second data signal Sd2 both having the same waveform, respectively. The first data signal Sd1 and the second data signal Sd2 are transmitted to the first pixel unit 211 and the second pixel unit 212 according to opposite directions (e.g., an upward direction and a downward direction) via the data line 251 and the data line 252, respectively. Please note that the first pixel unit 211 and the second pixel unit 212 here are respectively coupled to the data line 251 and the data line 252, and selectively receive the first data signal Sd1 and the second data signal Sd2 according to the first gate signal S1 and the second gate signal S2, respectively. In other words, the pixel structure formed by the first pixel unit 211 and the second pixel unit 212 has a horizontal symmetric compensation mechanism applied to gate signals as well as a vertical symmetric compensation mechanism applied to data signals. However, as long as at least one pixel structure has a symmetric compensation mechanism applied to at least one type of signals, such a display apparatus obeys the spirit of the present invention.

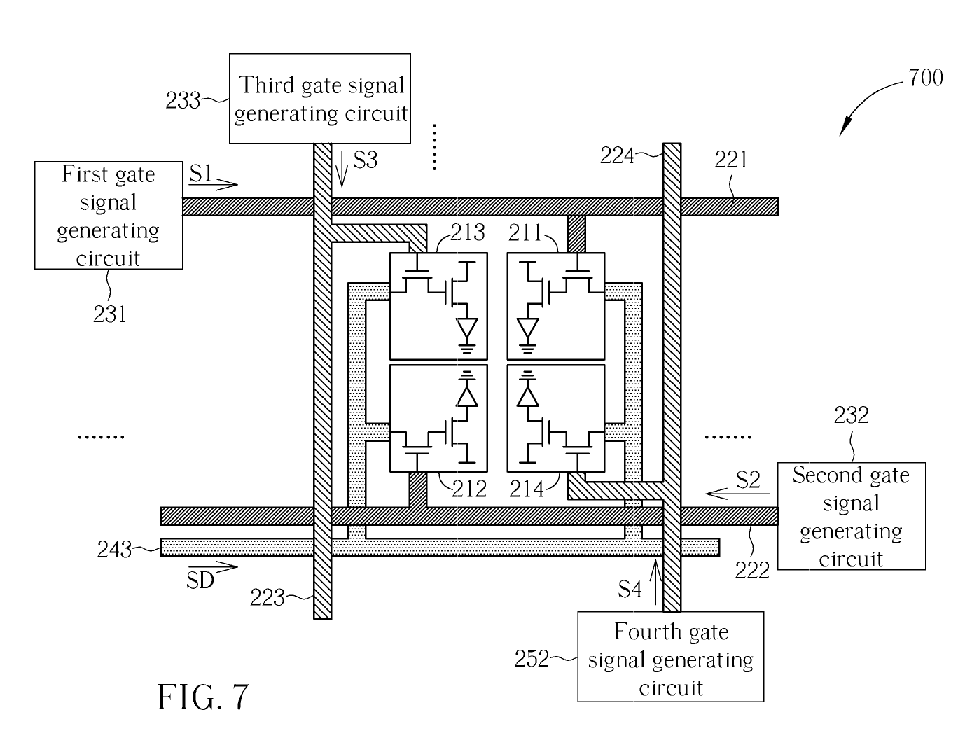

The aforementioned exemplary embodiments utilize two opposite signal transmission directions (e.g., upward and downward directions or leftward and rightward directions) to apply symmetric compensation to a same type of pixel driving signals. However, it is not meant to be a limitation to the present invention. Please refer to FIG. 7, which is a diagram illustrating part of a display apparatus 700 realized in another exemplary embodiment of the present invention. Compared with the display apparatus 200 shown in FIG. 2A, each pixel structure in the display apparatus 700 is composed of four pixel units, and performs symmetric compensation via four symmetric directions (e.g., upward, downward, leftward, and rightward directions). In detail, the display apparatus 700 includes, but is not limited to, a first pixel unit 211, a second pixel unit 212, a third pixel unit 214, a fourth pixel unit 214, a first transmission line 221, a second transmission line 222, a third transmission line 223, a fourth transmission line 224, a data line 243, a first gate signal generating circuit 231, a second gate signal generating circuit 232, a third gate signal generating circuit 233, and a fourth gate signal generating circuit 234. The first pixel unit 211, the second pixel unit 212, the third pixel unit 213, the fourth pixel unit 214 are utilized for forming a pixel structure that is used to display a video frame. Moreover, the third transmission line 223 is parallel with and adjacent to the fourth transmission line 224, and the third transmission line 223 and the fourth transmission line 224 are coupled to the third pixel unit 213 and the fourth pixel unit 214, respectively. The first gate signal generating circuit 231, the second gate signal generating circuit 232, the third gate signal generating circuit 233, and the fourth gate signal generating circuit 234 respectively generate the first gate signal S1, the second gate signal S2, the third gate signal S3, and the fourth gate signal S4 each having an identical waveform, and respectively transmit the first gate signal S1, the second gate signal S2, the third gate signal S3, the fourth gate signal S4 via the first transmission line 221, the second transmission line 222, the third transmission line 223, the fourth transmission line 224 according to a plurality of different signal transmission directions (e.g., four symmetric directions including the upward, downward, leftward, and rightward directions). The first pixel unit 211, the second pixel unit 212, the third pixel unit 213, the fourth pixel unit 214 receive the data signal SD via the data line 243.

Please note that those skilled in the art should readily understand the operation of the display apparatus 700 shown in FIG. 7 after reading paragraphs directed to the aforementioned exemplary embodiments. Thus, further description is omitted here for brevity.

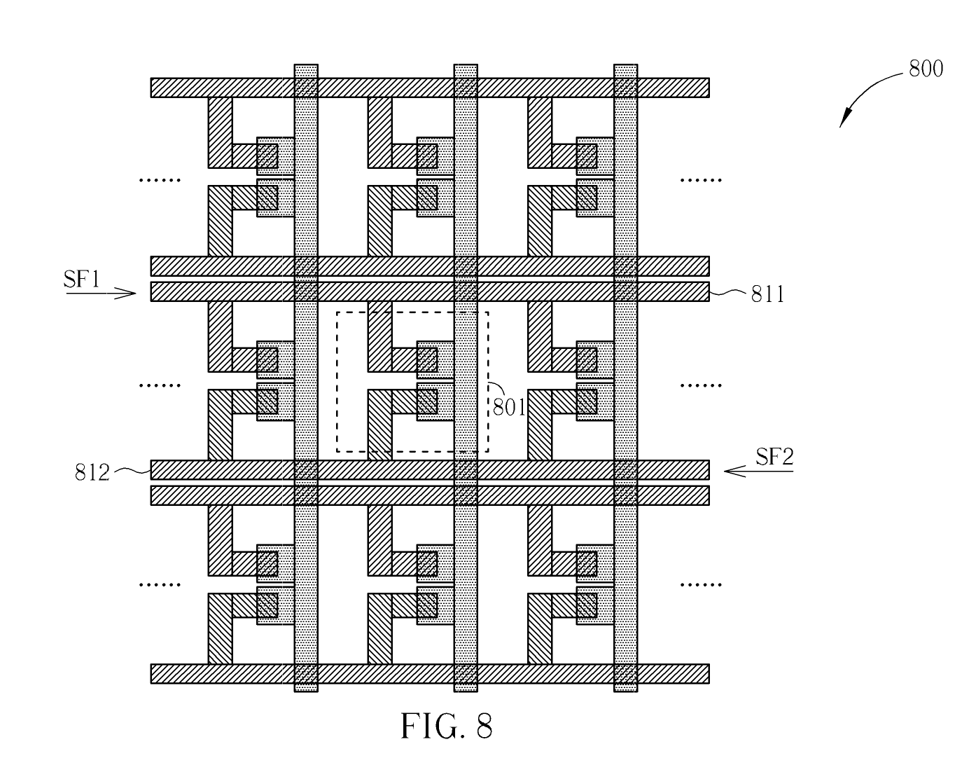

The aforementioned exemplary embodiments all utilize an OLED display to illustrate the technical features of the present invention. However, it is not meant to be a limitation of the present invention. In addition to the OLED display, the present invention may also be utilized in a self-luminous display apparatus with a better aperture ratio, such as a plasma display panel (PDP) or a field emission display (FED). The PDP is manufactured by injecting specific gas into vacuum glass tubes. By applying a suitable voltage to enable plasma discharge, the phosphor powder is excited to emit light beams, thereby generating different brightness via different lengths of excitation time. The FED utilizes cathode-ray tubes arranged in a matrix, wherein the cathode-ray tube emits electrons to hit the phosphor powder coating to generate light beams. The FED does not utilize transistors. Thus, compared with the general thin film transistor-liquid crystal display (TFT-LCD), the light transmission rate of the FED is greatly increased. For example, please refer to FIG. 8, which is a diagram illustrating part of an FED 800 realized by an exemplary embodiment of the present invention. The FED 800 includes a matrix of a plurality of pixel structures. Each pixel structure (e.g., the pixel structure 801) includes two identical pixel units for receiving driving signals SF1 and SF2 from a top signal line 811 and a bottom signal line 812, respectively. Similarly, the driving signals SF1 and SF2 have the same timing and waveform. Thus, even if the driving signals SF1 and SF2 undergo a long-distance transmission, each pixel structure disposed in the same row where the pixel structure 801 is located receives an identical sum of intensity of the driving signals (i.e., SF1+SF2).

Briefly summarized, the present invention provides a driving method that is based on symmetric signal transmission and utilized in a display apparatus and related display apparatus. By applying symmetric compensation to one or a plurality of types of signals and transmitting signals of a same type to each pixel structure in different symmetric directions, the problem of un-uniform brightness of a display panel is mitigated greatly, resulting in a favorable visual effect.

Those skilled in the art will readily observe that numerous modifications and alterations of the device and method may be made while retaining the teachings of the invention.

What is claimed is:

1. A driving method utilized for a display apparatus, the display apparatus comprising a plurality of first groups of pixel units, a plurality of second groups of pixel units, a first group of transmission lines and a second group of transmission lines, the first group of transmission lines and the second group of transmission lines being electrically connected to the first groups of pixel units and the second groups of pixel units, respectively, the first groups of pixel units being disposed adjacent to the second groups of pixel units, the driving method comprising:
generating a first input signal and a second input signal, wherein the first input signal and the second input signal comprise a plurality of input signals each having an identical waveform; and
transmitting the first input signal and the second input signal to the first groups of transmission lines and the second groups of transmission lines, respectively, such that the first input signal and the second input signal are transmitted to the first groups of pixel units and the second groups of pixel units according to a plurality of different signal transmission directions, respectively;
wherein signals provided to pixel units of a panel change when propagating via transmission lines, and the signals are compensated by utilizing a multi-input complementary transmission line layout with inputs having a same transmission timing or a geometrically-symmetric complementary transmission line layout with inputs having a same transmission timing.

2. The driving method of claim 1, wherein the signal transmission directions comprise a first signal transmission direction and a second signal transmission direction, and the first signal transmission direction is opposite to the second signal transmission direction.

3. The driving method of claim 1, wherein a sum of intensity of the input signals received by each first group of pixel units is substantially equal to a sum of intensity of the input signals received by a second group of pixel units corresponding to the first group of pixel units.

4. The driving method of claim 1, wherein the first input signal and the second input signal both are gate signals, data signals or reference voltages.

5. The driving method of claim 1, wherein each pixel unit comprises at least an organic light emitting diode (OLED).

6. The driving method of claim 1, wherein the display apparatus further comprises a plurality of auxiliary pixel units and a plurality of groups of auxiliary transmission lines, the groups of auxiliary transmission lines are respectively coupled to the auxiliary pixel units, and the driving method further comprises:
generating an auxiliary input signal, wherein the auxiliary input signal comprises a plurality of input signals each having a waveform identical to the waveform of the first input signal and the second input signal;
transmitting the first input signal, the second input signal and the auxiliary input signal to the first groups of transmission lines, the second groups of transmission lines and the groups of auxiliary transmission lines, respectively, such that the first input signal, the second input signal and the auxiliary input signal are transmitted to the first groups of pixel units, the second groups of pixel units and the auxiliary pixel units according to a plurality of different signal transmission directions, respectively.

7. A display apparatus, comprising:
a first pixel unit and a second pixel unit, for displaying a frame;
a first transmission line and a second transmission line, respectively coupled to the first pixel unit and the second pixel unit; and
a first input signal generating circuit and a second input signal generating circuit, respectively coupled to the first transmission line and the second transmission line, wherein the first input signal generating circuit and the second input signal generating circuit respectively generate a first input signal and a second input signal each having an identical waveform, and transmit the first input signal and the second input signal via the first transmission line and the second transmission line according to a plurality of different signal transmission directions, respectively;
wherein signals provided to pixel units of a panel change when propagating via transmission lines, and the signals are compensated by utilizing a multi-input complementary transmission line layout with multiple inputs having a same transmission timing or a geometrically-symmetric complementary transmission line layout with inputs having a same transmission timing.

8. The display apparatus of claim 7, wherein the signal transmission directions comprise a first signal transmission direction and a second signal transmission direction, and the first signal transmission direction is opposite to the second signal transmission direction.

9. The display apparatus of claim 8, wherein the first input signal generating circuit and the second input signal generating circuit are respectively disposed on two sides of a display region within the display apparatus.

10. The display apparatus of claim 8, wherein the first transmission line is parallel with and adjacent to the second transmission line.

11. The display apparatus of claim 7, wherein the first pixel unit and the second pixel unit are disposed alternatively.

12. The display apparatus of claim 7, wherein a sum of intensity of the first input signal received by the first pixel unit is substantially equal to a sum of intensity of the second input signal received by the second pixel unit.

13. The display apparatus of claim 7, wherein the first input signal and the second input signal generated by the input signal generating circuit are both gate signals, the display apparatus comprises a plurality of data lines for transmitting a plurality of data signals, and the first pixel unit and the second pixel unit are coupled to a same data line, and receive a same data signal during a same period.

14. The display apparatus of claim 7, wherein the first input signal and the second input signal generated by the input signal generating circuit are both data signals, the display apparatus comprises a plurality of gate lines for transmitting a plurality of gate signals, and the first pixel unit and the second pixel unit are coupled to a same gate line, and receive a same gate signal during a same period.

15. The display apparatus of claim 7, wherein plurality of input signals generated by the input signal generating circuit are both reference voltages, the display apparatus comprises a plurality of gate lines and a plurality of data lines for transmitting a plurality of gate signals and a plurality of data signals, respectively, and the first pixel unit and the second pixel unit are coupled to a same gate line and a same data line, and receive a same data signal during a same period.

16. The display apparatus of claim 7, further comprising:
a plurality of auxiliary pixel units, for displaying a frame;
a plurality of auxiliary transmission lines, respectively coupled to the auxiliary pixel units; and
at least an auxiliary input signal generating circuit, respectively coupled to the groups of auxiliary transmission lines, for generating an auxiliary input signal, wherein the auxiliary input signal comprises a plurality of input signals each having a waveform identical to the waveform of the first input signal and the second input signal, the first input signal, the second input signal and the auxiliary input signal are transmitted to the first group of pixel units, the second group of pixel units and the auxiliary pixel units via the first group of transmission lines, the second group of transmission lines and the groups of auxiliary transmission lines according to a plurality of different signal transmission directions, respectively.

17. The display apparatus of claim 7, wherein each pixel unit comprises at least one organic light emitting diode (OLED).

18. The display apparatus of claim 7, wherein the first pixel unit has a gate terminal for receiving a gate signal, a data terminal for receiving a data signal and a reference voltage terminal for receiving a reference voltage, and the first pixel unit comprises:
a switch component, having a switch terminal coupled to the gate terminal, a first terminal coupled to the reference voltage terminal and a second terminal, for selectively conducting a data signal from the data terminal to the second terminal according to the gate signal; and
a light emitting component, having a first terminal coupled to the second terminal of the switch component and a second terminal coupled to a ground terminal, for emitting light according to the data signal transmitted through the switch component.

19. The display apparatus of claim 18, wherein the second pixel unit has a gate terminal for receiving a gate signal, a data terminal for receiving a data signal and a reference voltage terminal for receiving a reference voltage, and the second pixel unit comprises:
a switch component, having a switch terminal coupled to the gate terminal of the second pixel unit, a first terminal coupled to the reference voltage terminal and a second terminal, for selectively conducting a data signal from the data terminal of the second pixel unit to the second terminal according to the gate signal, selectively; and
a light emitting component, having a first terminal coupled to the second terminal of the switch component and a second terminal coupled to the ground terminal, for emitting light according to the data signal transmitted through the switch component of the second pixel unit.

20. The display apparatus of claim 19, wherein the first pixel unit and the second pixel unit receive input signals each having an identical waveform, and the first pixel unit and the second pixel unit are disposed in a stacked manner.
